(19) United States
(12) Patent Application Publication
(10) Pub. No.: US 2013/0304575 A1
(43) Pub. Date: Nov. 14, 2013

(54) SYSTEMS, METHODS AND MACHINE-READABLE MEDIA FOR PROVIDING AND MANAGING AN INTERFACE BETWEEN FANS AND CELEBRITIES WITHIN A SOCIAL NETWORK ENVIRONMENT

(71) Applicant: Michael Fetyko, Costa Mesa, CA (US)

(72) Inventor: Michael Fetyko, Costa Mesa, CA (US)

(21) Appl. No.: 13/891,108

(22) Filed: May 9, 2013

Related U.S. Application Data
(60) Provisional application No. 61/645,041, filed on May 9, 2012.

(51) Int. Cl. H04L 29/06

(52) U.S. Cl. CPC H04L 65/403
USPC 705/14.53; 715/730; 705/14.49

(57) ABSTRACT

Systems, methods and machine-readable media for providing an interface between fans and celebrities are disclosed. The methods include prompting, via a processor, a plurality of users to participate in a programming session with a celebrity; storing a plurality of media submissions in a memory, each media submission being associated with a user for consideration and presentation to the celebrity during the programming session; selecting, via the processor and based on at least one predetermined criteria, at least one of the plurality of the media submissions for presentation during the programming session; and identifying, via the processor, the selection of a user's media submission for presentation during the programming session on at least one social network account associated with the user. The systems and machine-readable media performing operations according to the methods disclosed.

### CROSS-REFERENCE TO RELATED APPLICATION

This application claims the benefit of U.S. Provisional Application No. 61/645,041, filed May 9, 2012.

### FIELD OF THE INVENTION

The present invention relates generally to a platform for connecting celebrities with their fans in a social networking environment that is both appealing to the consumers and to hosts, and in particular, to systems, methods and machine-readable media that includes a variety of user interfaces facilitating communication between celebrities and their fans.

### BACKGROUND

The ubiquity of social networking has changed both the methodology and the psychology of how the public communicates with private figures. Whether a celebrity posts on Facebook® or tweets on Twitter®, or simply appears in any other social network, fans of the celebrity have almost instant connection with the celebrities. In the past, such fans waited for weekly magazines or daily reported articles in papers and the internet. For many, the real time communication provides sufficient gratification to sustain the long term viability of the network for the star gazers among us.

But many users want more than just one way communication with notable private figures and celebrities. To some limited degree, two way communication has historically been provided in the form of hosted talk shows, whether broadcast on TV or the radio, where a caller or audience member has been given an opportunity to ask a question to a celebrity or, in rarer occasions, engage in a dialogue with the celebrity.

### SUMMARY OF THE INVENTION

Systems, methods and machine-readable media for providing an interface between fans and celebrities are disclosed. In one embodiment, the method comprises prompting, via a processor, a plurality of users to participate in a programming session with a celebrity; storing a plurality of media submissions in a memory, each media submission being associated with a user for consideration and presentation to the celebrity during the programming session; selecting, via the processor and based on at least one predetermined criteria, at least one of the plurality of the media submissions for presentation during the programming session; and identifying, via the processor, the selection of a user's media submission for presentation during the programming session on at least one social network account associated with the user.

In one embodiment, the method may further comprise integrating, via the processor, an advertisement banner with the interface between fans and celebrities; and/or integrating, via the processor, an advertisement banner with the at least one social network account associated with the user interface between fans and celebrities.

As can be appreciated, the predetermined criteria may be a random selection of the at least one of the plurality of the media submissions. The predetermined criteria may be based upon a number of credits issued to or purchased by the plurality of users.

In one embodiment, the method further comprises streaming the programming session live for output at a user's terminal. The streaming of the programming session may comprise transmitting video data of at least one of the celebrity and the event management personnel for video output at the user's terminal.

According to an embodiment of the present disclosure, a machine-readable medium provides instructions, which when read by a machine having a processor and a memory, cause the machine to perform operations, comprising: prompting, via the processor, a plurality of users to participate in a programming session with a celebrity; storing a plurality of media submissions in the memory, each media submission being associated with a user for consideration and presentation to the celebrity during the programming session; selecting, via the processor and based on at least one predetermined criteria, at least one of the plurality of the media submissions for presentation during the programming session; and identifying, via the processor, the selection of a user's media submission for presentation during the programming session on at least one social network account associated with the user.

The machine-readable medium may further provide instructions to cause the machine to integrate, via the processor, an advertisement banner with the interface between consumers and celebrities; and/or integrating, via the processor, an advertisement banner with the at least one social network account associated with the user interface between consumers and celebrities. In one embodiment, the machine-readable medium may further provide instructions to cause the machine to stream the programming session live for output at a user's terminal.

According to another embodiment, a system for providing an interface between fans and celebrities is provided. The system comprising a memory and a processor. The memory may be used for storing a plurality of media submissions, each media submission being associated with a user for consideration and presentation to the celebrity during the programming session. The processor may be programmed with instructions to: prompt a plurality of users to participate in a programming session with a celebrity; select, based on at least one predetermined criteria, at least one of the plurality of the media submissions for presentation during the programming session; and identify the selection of a user's media submission for presentation during the programming session on at least one social network account associated with the user. In one embodiment, the processor may be programmed with instructions to integrate an advertisement banner with the interface between fans and celebrities; and stream the programming session live for output at a user's terminal.

### BRIEF DESCRIPTION OF THE FIGURES

FIG. 1 illustrates an exemplary schematic representation of the information and/or activities viewable through a web portal system accessible by an end user, according to an embodiment of the present disclosure;

FIG. 2 illustrates exemplary features associated with marketing mode viewable through the end user web portal of FIG. 1, according to an embodiment of the present disclosure;

FIG. 3 illustrates exemplary features associated with live mode viewable through the end user web portal of FIG. 1, according to an embodiment of the present disclosure;

FIG. 4 illustrates exemplary features associated with archive mode viewable through the end user web portal of FIG. 1, according to an embodiment of the present disclosure;

FIG. 5 illustrates an exemplary schematic representation of the information and/or activities viewable through a web portal accessible by a celebrity guest, according to an embodiment of the present disclosure;

FIG. 6 illustrates an exemplary login page viewable through the guest web portal of FIG. 5, according to an embodiment of the present disclosure;

FIG. 7 illustrates an exemplary early login page viewable through the guest web portal of FIG. 5, according to an embodiment of the present disclosure;

FIG. 8 illustrates an exemplary early successful login page viewable through the guest web portal of FIG. 5, according to an embodiment of the present disclosure.

FIG. 9 illustrates an exemplary flow chart of a method for providing an interface between consumers and celebrities, according to an embodiment of the present disclosure.

### DETAILED DESCRIPTION

The following detailed description includes representative examples utilizing numerous features and teachings, both separately and in combination, that relates to systems, methods and machine-readable media for providing and managing an interface between consumers and celebrities within a social network environment. This detailed description is merely intended to teach a person of skill in the art further details for practicing preferred aspects of the present teachings and is not intended to limit the scope of the claims. Therefore, combinations of features disclosed in the following detailed description and incorporated documents may not be necessary to practice the teachings in the broadest sense, and are instead taught merely to describe particularly representative examples of the present teachings.

Some portions of the detailed descriptions that follow in the incorporated documents are presented in terms of algorithms and sequences of operations which are performed within a computer memory. These algorithmic descriptions and representations are the means used by those skilled in the data processing arts to most effectively convey the substance of their work to others skilled in the art. An algorithm or sequence of operations is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic device, that manipulates and transforms data represented as physical (electronic) quantities within the computer system's registers and memories into other data similarly represented as physical quantities within the electronic device's memory or registers or other such information storage, transmission or display devices.

The embodiments disclosed also relate to an apparatus for performing the operations herein. This apparatus may be specially constructed for the required purposes, or it may comprise a general purpose processor selectively activated or reconfigured by a computer program stored in the electronic device. Such a computer program may be stored in a computer readable storage medium, such as, but is not limited to, any type of disk, including floppy disks, optical disks, CD-ROMs, and magnetic-optical disks, read-only memories (ROMs), random access memories (RAMs), EPROMs, EEPROMs, Flash memory, magnetic or optical cards, or any type of media suitable for storing electronic instructions, and each coupled to a computer system bus.

The algorithms presented herein are not inherently related to any particular electronic device or other apparatus. Various general purpose systems may be used with programs in accordance with the teachings herein, or it may prove convenient to construct a more specialized apparatus to perform the required method steps. The required structure for a variety of these systems will appear from the description below. It will be appreciated that a variety of programming languages may be used to implement the teachings of the embodiments as described herein.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples. Embodiments of the present invention comprise four distinct interfaces: a content destination widget, an artist console, and event management interface (that itself comprises and event management console and a live mode console), and super administration. The “destination” site is the primary consumer interface for the system. It can function as a stand alone application. The widget supports full integration of social networking extensions and services. The destination site comprises three interface states: pre-event, or marketing mode; live event, or on air mode; and post-event, or archive mode.

For the purposes of this disclosure, the term “content” or “media” is used broadly to encompass any product type or category of creative work including any work that is in an electronic form that is renderable, experienceable, retrievable, computer-readable filed and/or stored in memory, either singly or collectively. Individual items of content or media include songs, tracks, pictures, images, movies, articles, books, ratings, reviews, descriptive tags, or computer-readable files, however, the use of any one term is not to be considered limiting as the concepts features and functions described herein are generally intended to apply to any work that may be experienced by a user, whether aurally, visually or otherwise, in any manner now known or to become known. Further, the term content or media includes audio, video and products embodying the same. As mentioned above, while there are many digital forms and standards for audio, video, digital or analog media data and content, embodiments of the systems and methods described herein may be equally adapted to any format or standard now known or to become known.

For purposes of this disclosure, the term “social network” refers to an online community in which community members can interact or transfer information and can include chat rooms, email accounts, forums, instant messaging, media/photo management and sharing. Further, the term “social network” refers to a web-based system for facilitating applications such as e-mail application, calendar application, chat room application, instant messaging application, and media/photo management and sharing application. As used herein, the term “celebrity” may include any individual or representative of any entity that may be known to one or more persons in a specific field and/or geographic location.

In one embodiment, the system may be implemented in one or more functional modules. As used herein, the term module refers to logic embodied in hardware or firmware, or to a collection of software instructions, possibly having entry and exit points, written in a programming language, such as, for example, C++. A software module may be compiled and linked into an executable program, or installed in a dynamic link library, or may be written in an interpretive language such as BASIC. It will be appreciated that software modules may be callable from other modules, and/or may be invoked in response to detected events or interrupts. Software instructions may be embedded in firmware, such as an EPROM. It will be further appreciated that hardware modules may be comprised of connected logic units, such as gates and flip-flops, and/or may be comprised of programmable units, such as programmable gate arrays. The modules described herein are preferably implemented as software modules, but could be represented in hardware or firmware.

In one embodiment, each module is provided as a modular code object, where the code objects typically interact through a set of standardized function calls. In one embodiment, the code objects are written in a suitable software language such as C++, but the code objects can be written in any low level or high level language. In one embodiment, the code modules are implemented in C++ and compiled on a computer running a content server, such as, for example, Microsoft™ IIS or Linux™ Apache. Alternatively, the code modules can be compiled with their own front end on a kiosk, or can be compiled on a cluster of server machines serving interactive television content through a cable, packet, telephone, satellite, or other telecommunications network. Artisans of skill in the art will recognize that any number of implementations, including code implementations directly to hardware, are also possible.

For example, the system may include a database. As is well known, database categories above can be combined, further divided or cross-correlated, and any combination of databases and the like can be provided from within a server. In one embodiment, any portion of the databases can be provided externally from the website, either locally on the server, or remotely over a network. The external data from an external database can be provided in any standardized form which the server can understand. For example, an external database at a provider can advantageously provide end-user data in response to requests from server in a standard format, such as, for example, name, user identification, and computer identification number, and the like, and the end-user data blocks are transformed by a database management module into a function call format which the code modules can understand. The database management module may be a standard SQL server, where dynamic requests from the server build forms from the various databases used by the website as well as store and retrieve related data on the various databases.

As can be appreciated, the databases may be used to store, arrange and retrieve data. The databases may be storage devices such as machine-readable mediums, which may be any mechanism that provides (i.e. stores and/or transmits) information in a form readable by a processor. For example, the machine-readable medium may be a read only memory (ROM), a random access memory (RAM), a cache, a hard disk drive, a floppy disk drive, a magnetic disk storage media, an optical storage media, a flash memory device or any other device capable of storing information. Additionally, machine-readable medium may also comprise computer storage media and communication media. Machine-readable medium includes volatile and non-volatile, removable and non-removable media implemented in any method or technology for storage of information such as computer-readable instructions, data structures, program modules or other data. Machine-readable medium also includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by a computer.

According to a feature of the present disclosure, a machine-readable medium is disclosed. The machine-readable medium provides instructions, which when read by a processor, cause the machine to perform operations described or illustrated herein. The machine-readable medium may be any mechanism that provides (i.e. stores and/or transmits) information in a form readable by the processor. For example, the machine-readable medium may be a read only memory (ROM), a random access memory (RAM), a cache, a hard disk drive, a floppy disk drive, a magnetic disk storage media, an optical storage media, a flash memory device or any other device capable of storing information.

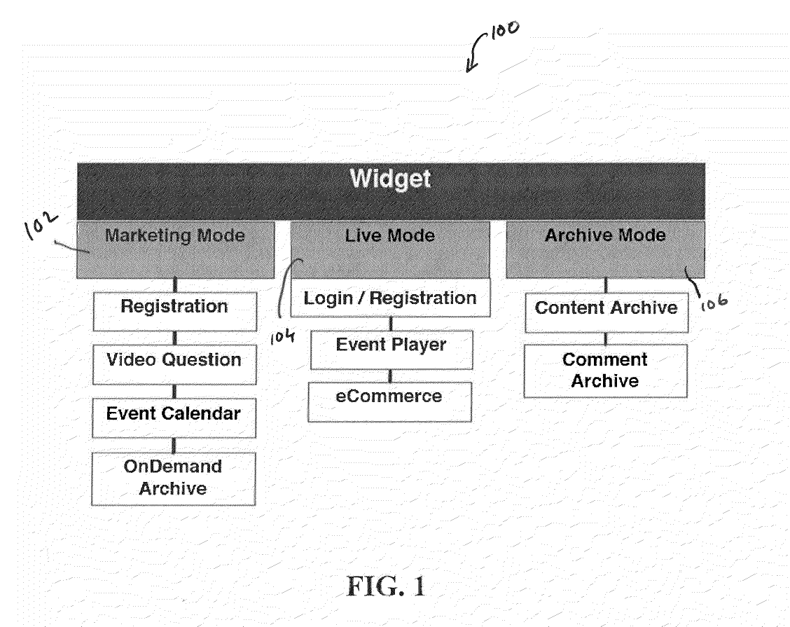

FIG. 1 illustrates an exemplary schematic representation of information and/or activities viewable through a web portal system 100 accessible by an end user, according to an embodiment of the present disclosure. In one embodiment, the system may include a marketing mode module 102, a live mode module 104 and an archive mode module 106. Each module may be used to trigger the operation of one or more websites. When an event has been scheduled, the marketing mode site may become available. The marketing mode site may be programmed with instructions to provide information and activity features such as: listing upcoming event; registration, both subscription and community formats; invitation to friends; recording a question; cross posting questions to social networks (e.g., Facebook and Twitter); sharing event on social networks; and customization of event and sponsorship.

The live mode module 104 may be programmed with instructions to provide one or more of the following features: live recording and video broadcast; ecommerce solutions (event ticket, merchandising, etc); display ads; comments; social media cross posting; share event on social networks; and invitation to identified friends. Once an event has occurred, the interface defaults to the archive mode module 106, which may be used to provide, for example, features such as: a list of upcoming events; joining the community; viewing a video on demand, i.e. an archival webcast; sharing the event; posting comments; and cross posting comment on a social network.

In another embodiment, the system may include an artist module. The artist module may be programmed with instructions to provide an interface that includes: registering for an event; viewing audience questions; and participating in a live video broadcast.

In yet another embodiment, the system may include an event management interface for event management personnel, and may comprise an event management module and a live mode module 104. The event management module may be programmed with instructions to provide the following features: program manager; event scheduling system; customization tools; advertising solutions; and community analytics. The live mode module 104 may be programmed with instructions to provide the following features: controls for starting and stopping the live event; pushing video questions to the stage; adjusting AV controls (DJ, star, user); and pushing additional content to the stage.

In one embodiment, the system may include an interface for administration. Administration at this level permits configuration of the system platform and account global settings. It may be role based and may comprise one or more of the following user types: a station administrator for a single radio station, who can manage settings for a single station; a network administrator within a network of stations, who can manage settings for plurality of different stations; and a super administrator, whose role comprises managing clients, accounting and billing, and all product functions.

In the context of a media outlet, the end user may participate by watching, interacting, buying, sharing and/or discussing in any of the following activities: watch live or prerecorded video; interact with event management personnel; submit video questions to the artist; chat with other end users; buy products with special broadcast promo pricing; and share the multi-step experience with friends each step of the way. The event management personnel may control and manage the system or assign staff and/or event administrators by, among other activities, start the audio and video live interview; select and mix user questions during the live broadcast; start surveys live; and participate in the celebrity interview. The artist (or celebrity) may participate simply by engaging in dialogue with the event management personnel or with end users who were selected to participate live. The artist may enter/log on to the system via the artist's own portal anywhere, whether from his home or remote location. Indeed, the embodiments of the present disclosure allow a celebrity to participate in multiple interviews with multiple stations in the same day, regardless of the artist's location. As can be appreciated, the system may be programmed with instructions to facilitate such activities.

From the perspective of the various system users, various system interfaces are possible and contemplated. By way of example, and presented schematically, the end user or listener may access one embodiment of the system through a web portal presenting a plurality of features such as that illustrated in FIG. 1. With such an arrangement, the interface comprises at least three modes: a marketing mode, a live mode and an archive mode, each with an independent set of possible activities and sources of information and exchange. For example, the marketing mode (module 102) may be programmed with instructions to facilitate registration, video questioning, event calendaring, and/or On-Demand archiving. The Live Mode (module 104) may be programmed with instructions to facilitate login/registration, event player(s) and/or e-commerce transactions. Meanwhile, the Archive Mode (module 106) may be programmed with instructions to facilitate content archiving and comment archiving.

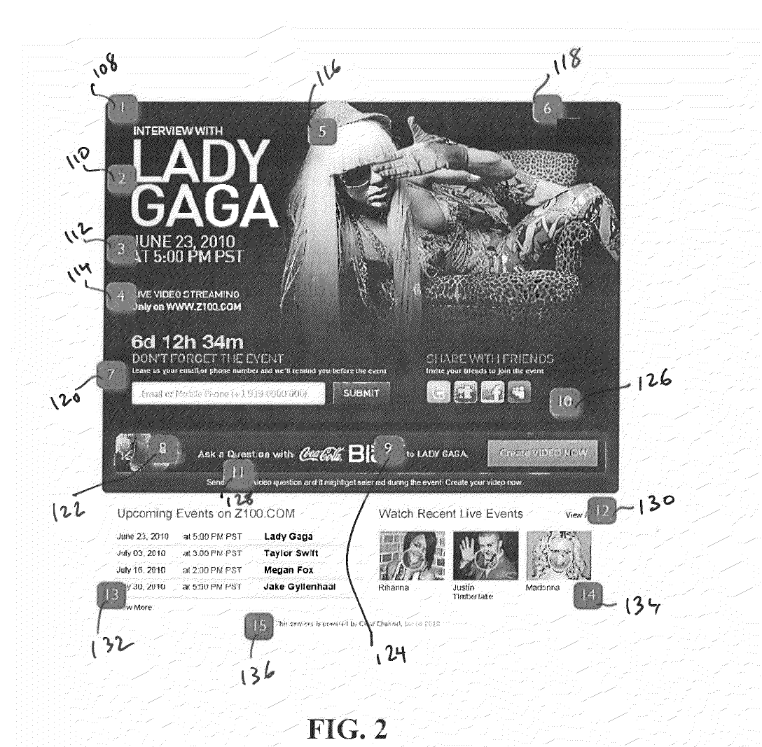

FIG. 2 illustrates exemplary features associated with marketing mode viewable through the end user web portal of FIG. 1, according to an embodiment of the present disclosure. In one embodiment, the marketing mode module 102 may be programmed with instructions to provide one or more of the following features: an event title 108 that may comprise a text event title retrieved from a database (not shown) associated with the system 100; an event guest name 110 that may be retrieved from the database; an event scheduling details 112 and a website url 114 retrieved from the database; an image 116 of a celebrity and can be uploaded to the portal site during event creation, or as otherwise desired or retrieved from the database; a company's I.D. 118 which may comprise either a logo or text associated with an account; and, a countdown timer and reminder notification 120, where the countdown timer may, for example, count down days, hours and minutes till the start of the event, with the balance of text residing as part of the page template.

In another embodiment, the marketing mode module 102 may be programmed with additional instructions to provide one or more of the following features: a registration input field(s) 122 that includes an input field to be filled in by the end user; and a registration submission button 124 for submitting info from the input field(s) 122.

As indicated above, a feature of certain embodiments of the present invention comprises linking one or more social media networks into the system so that any activity engaged by the end user (e.g., fan) may be cross posted on such social media networks. The marketing mode module 102 may be integrated with such social media links 126. As can be appreciated, the marketing mode module 102 may be programmed with instructions to facilitate presentation and/or introduction and/or placement, by way of example, of a banner/advertisement 128 for sponsor branding. As shown in FIG. 2, the banner/advertisement 128 may be placed in association with the functionality of creating a video question for submission. The marketing mode module 102 may be programmed with instructions to present a create video question button 130 that permits a user to start video submission workflow as discussed below. As can be appreciated, sponsor branding may, of course, be presented as part of or in association with any other feature described herein, if so desired.

In one embodiment, the marketing mode module 102 may be programmed with instructions to present an upcoming events list 132 comprising a list of, for example, the next 4 scheduled events, with the ability to link to a more comprehensive list, if so desired; present an on-demand list 134 of archived events that may be viewed in video format; and present a footer 136 where the host company may identify itself in static or dynamic format.

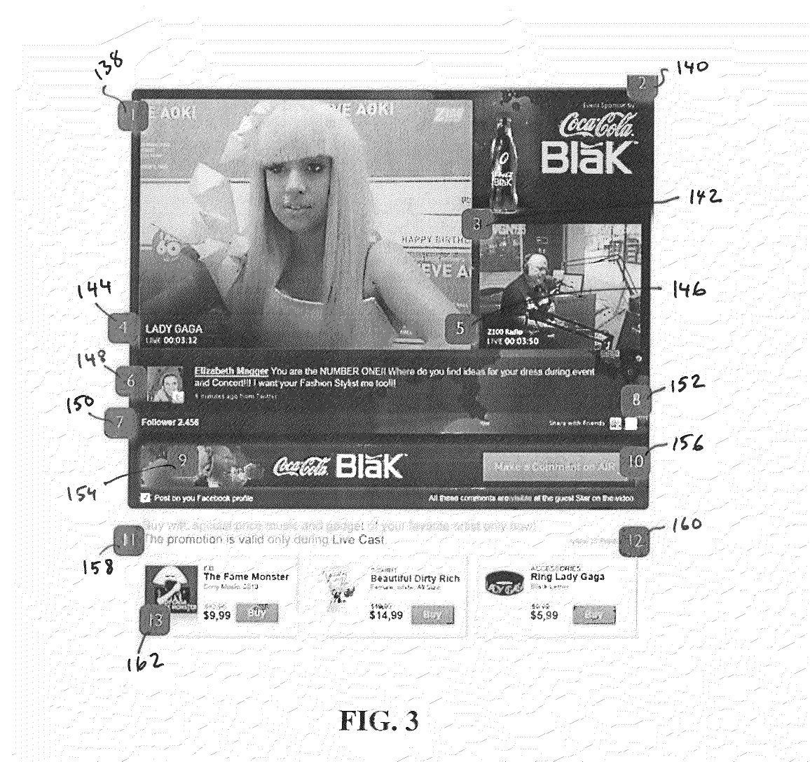

FIG. 3 illustrates exemplary features associated with live mode viewable through the end user web portal of FIG. 1, according to an embodiment of the present disclosure. In one embodiment, the live mode module 104 may be programmed with instructions to provide one or more of the following features: present a view/window 138 of the main stage, which comprises the guest (i.e., celebrity) feed or the event management personnel, depending upon the settings; present one of several possible sponsor blocks 140; present a view/window 142 of the event management personnel, which may comprise a persistent feed from the host when the main stage is occupied by the celebrity guest; present a star and status indication 144 that may comprise a text overlay of the guest name and the status (e.g., live); present the company I.D. and status indication 146 that may comprise, for example, text overlay; and present a comment display viewer 148 that may comprise a display of one or more of recent community comments.

In one embodiment, the live mode module 104 may also be programmed with instructions to provide one or more of the following features: present an attendee counter 150; present social media links 152; present one or more sponsor blocks 154, which may include a button 156 for the user to submit a comment and may comprise a comment creation overlay; and present an eCommerce window 158 that may comprise special promotional items that may be available for purchase. As can be appreciated, purchase transactions may occur, for example, in a pop-up window. In one embodiment, the live mode module 104 may also be programmed with instructions to provide one or more of the following features: present a link 160 to view all products that comprise a listing of all products; and present a featured product block 162 that may comprise a display of one or more featured products. Each featured product may comprise a thumbnail; information about the product type; a product name; a source; the offered price; and a button that permits real time purchase by the user.

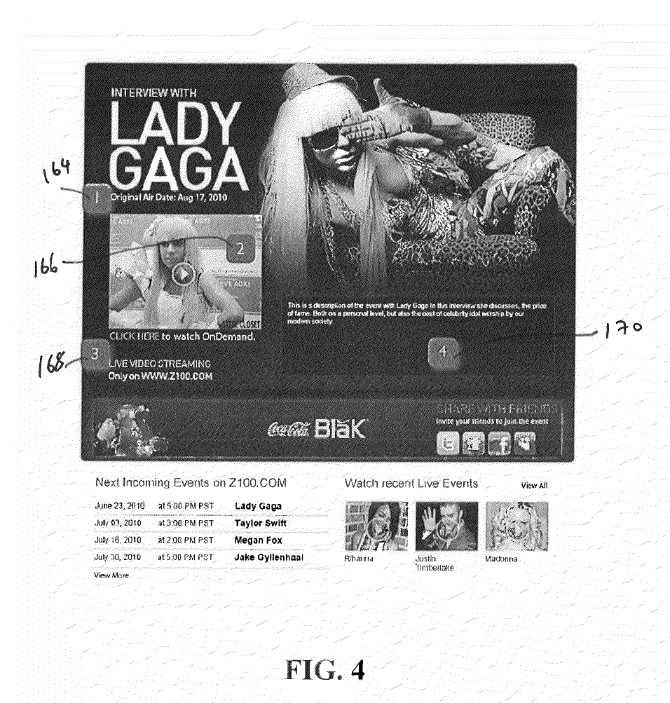

FIG. 4 illustrates exemplary features associated with archive mode viewable through the end user web portal of FIG. 1, according to an embodiment of the present disclosure. In one embodiment, the live mode module 104 may be programmed with instructions to provide one or more of the following features: present an event date 164 that may comprise the date that an event of interest to the user took place, where the presentation of the date may be in any one of numerous possible configurations; present an archive video player thumbnail 166 that may comprise a link to an archived video file; present a website url 168 (similar to url 114); and present an event description 170 that may comprise a text box with a description of the interview.

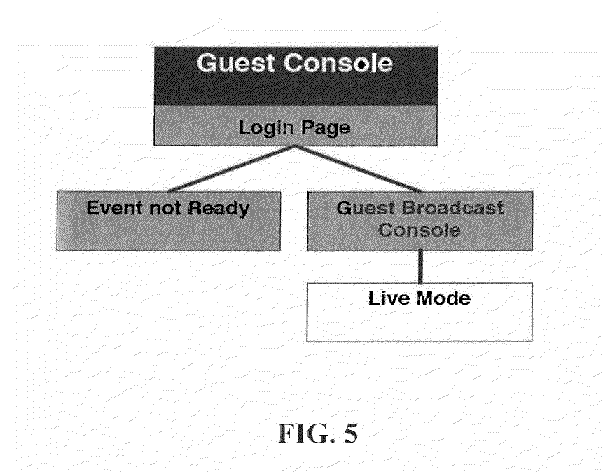

The above several paragraphs reflect a description of features and GUI embodying a web portal for end users (e.g., listeners and fans) provided in the system 100. The guest (i.e., celebrity, artist or other public figure) portal may comprise schematically possible steps, depending on whether the event is ready or not for broadcasting, as shown in FIG. 5.

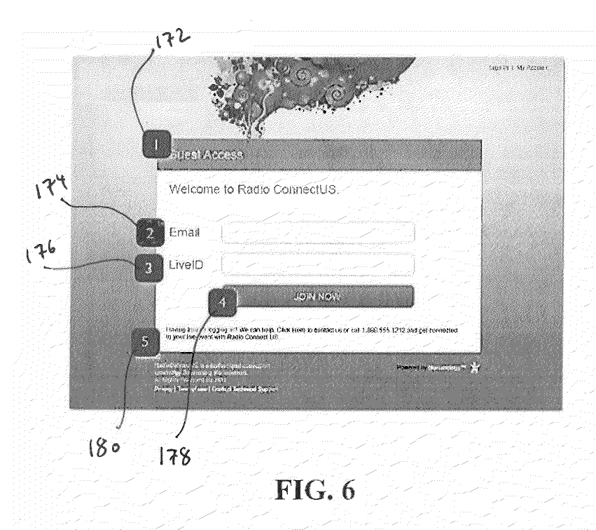

FIG. 6 illustrates an exemplary login page viewable through the guest web portal of FIG. 5, according to an embodiment of the present disclosure. The login page may include a login panel/window 172 for the guest; a guest registration field 174, for example, a field for inputting a guest's email or other pertinent information about the guest; an I.D. field 176 for entering an authorized identification code dedicated to the guest for a particular event; and a submission button/link 178 for the guest to submit relevant credentials and to enter the system 100. As can be appreciated, the login page may include a link for providing helpful explanations 180 about one or more features of the system 100.

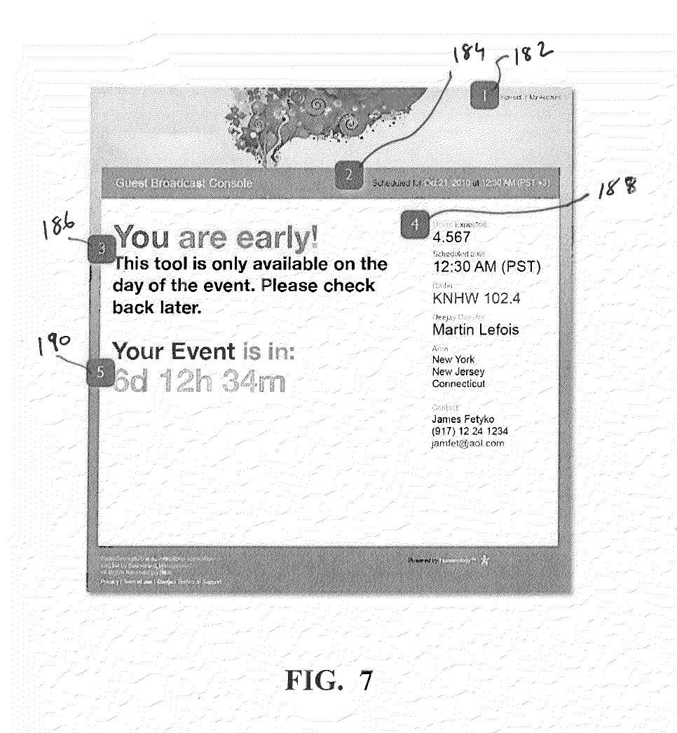

As shown in FIG. 5, the system 100 may be programmed with instructions to permit a guest to join early if so desired and visit the site to either learn how to navigate or simply to confirm certain information about an upcoming event. In that regard, FIG. 7 presents an exemplary GUI associated with early login, according to an embodiment of the present disclosure. In one embodiment, the exemplary early login page may include a link 182 that permits the guest to either sign out or to access the user's account for editing or updating purposes; an event scheduling information 184 that may comprise, for example, date, time and time zone; an event message 186 that may comprise a text status message indicating the user is too early; and an event information data 188 that may comprise a display of relevant information. This relevant information may include, for example: the pre-registered user count; the scheduled time; the company ID, the name of the event management personnel; the geographic areas represented; and the relevant point of contact. In one embodiment, the exemplary early login page may also include an event countdown timer 190.

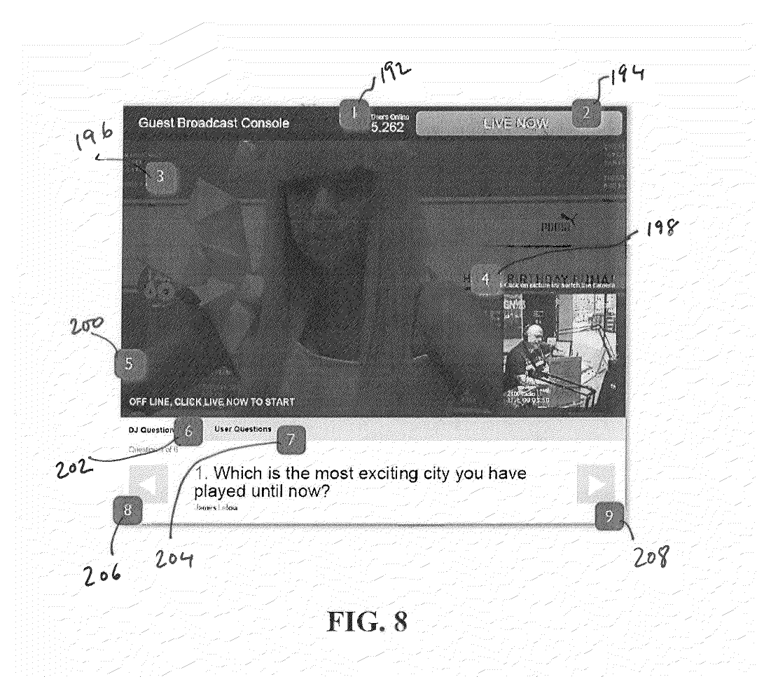

FIG. 8 illustrates an exemplary early successful login page viewable through the guest web portal of FIG. 5, according to an embodiment of the present disclosure. As with other web portal pages displayed for embodiments of the present disclosure, there are a number of possible informative features and links. The successful login page may include an indicator 192 of the number of users who are currently online to watch and/or participate in the event in which the guest celebrity is involved; a go live button 194 that, upon selecting, activates the guest's video feed and changes the player status to live mode; a guest video feed preview 196; a video feed 198 of the event management personnel; an indicator 200 reflecting an “Off Line” or “Online” status depending on if the event management personnel has started the event; an event management personnel questions tab 202 that may comprise a list of prewritten questions from the event management personnel; and a user questions tab 204 that may comprise a list of user video questions selected by the event management personnel. In one embodiment, the successful login page may include a previous question button 206 that displays the previous question and/or an advance question button 208 that displays the next question.

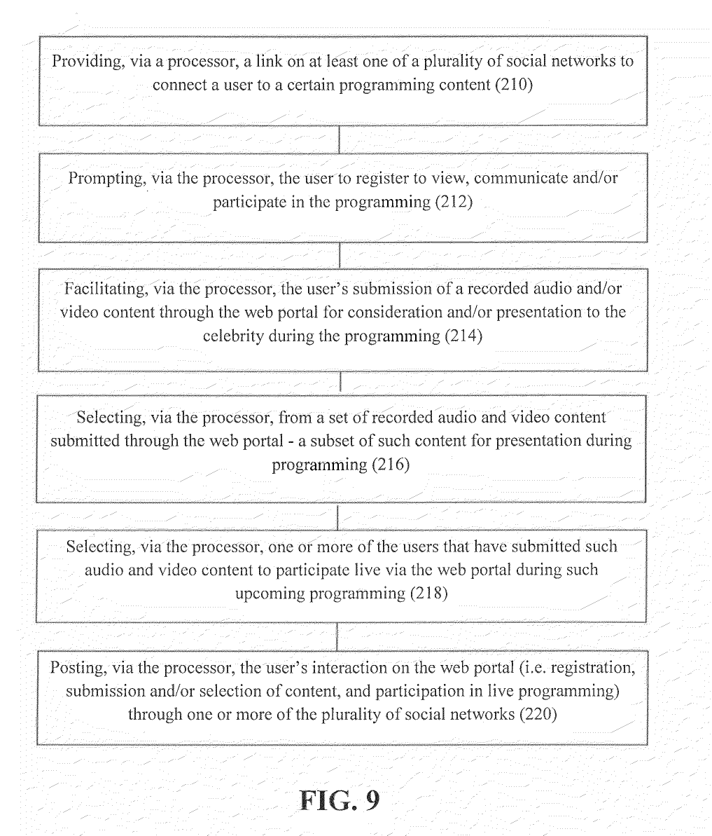

FIG. 9 illustrates an exemplary flow chart of a method for providing an interface between consumers and celebrities, according to an embodiment of the present disclosure. The method may include providing, via a processor, a link on at least one of a plurality of social networks to connect a user to a certain programming content, for example a live interview with a celebrity (210); and prompting, via the processor, the user to register to view, communicate and/or participate in the programming (212). For example, providing a registration vehicle through the infrastructure's web portal accessible to the user who desires to communicate with those participating in the programming, including celebrities. In one embodiment, the method may also include facilitating, via the processor, the user's submission of a recorded audio and/or video content through the web portal for consideration and/or presentation to the celebrity during the programming (214). The recorded audio and/or video (media submission) may be stored in a memory and retried if and when selected for presentation to the celebrity. In one embodiment, selection of media submission may be based on certain predetermined criteria. For example, it may be based upon the distribution of credits issued to potential users, where the number of submissions correlates to the number of credits issued, and/or where the user may accumulate additional credits by satisfying certain criteria. In one embodiment, the criteria for accumulating additional credits may include, for example, purchasing such additional credits. Alternatively, selection of media submissions may be randomized.

Furthermore, the method may also include selecting, via the processor, from a set of recorded audio and video content submitted through the web portal—a subset of such content for presentation during programming (216). The set of submitted recorded content may be weighted in the user's favor by the repeated submission of the user's recorded audio and video content and/or based upon the number of credits issued to the user, thereby increasing the chance of the user's content being selected.

In one embodiment, the method may further include selecting, via the processor, one or more of the users that have submitted such audio and video content to participate live via the web portal during such upcoming programming (218); and posting, via the processor, the user's interaction on the web portal (i.e. registration, submission and/or selection of content, and participation in live programming) through one or more of the plurality of social networks (220). The posting may be in the form of identifying, via the processor, the selection of a user's media submission for presentation during the programming session on at least one social network account associated with the user.

As can be appreciated, the method may further include integrating, via the processor, an advertisement banner in the web portal and/or through the social network posts. The advertisement banner may comprise integrating advertising space in virtual buttons provided on the web portal.

In one embodiment, a method of conducting a programming on a network is provided. The method may include providing, via a processor, a first web portal for receiving voice data over a network; receiving, via the processor, voice data over the network; transmitting, via the processor, the voice data over the network; receiving a comment and/or question as an input from a user via a second web portal; and submitting the comment and/or question based on the input from the user during the programming to the celebrity.

In one embodiment, the systems and methods of the present disclosure may be used to interface between fans and celebrities within a social network environment. For example, the system may be configured for access by several categories of persons seeking to accomplish related by differing schemes. In that regard, one category may comprise administrators who may control the particulars of the systems and methods in a manner that most effectively manages the interface between consumers (or fans) and, e.g., noteworthy public figures. Another category may comprise celebrities themselves, who desire to connect with their fans and promote themselves in productive and enjoyable manners. Yet another category may comprise the consumers or fans who desire to connect with the celebrities using the platform particulars established by the administrator (alone or in association with the celebrities). A further category may comprise advertisers who can promote products and services to the consumers who desire to connect with the celebrities. As can be appreciated, other categories may be possible for those who have some interest, economic or not, in the social experience provided by the inventive embodiments herein.

It is contemplated, for example, that celebrities (e.g., artists) may broadcast a custom live interview in real-time from their home, studio or live concert location. End users (consumers, fans, etc.) may interact with artists and generate content with a unique set of interactive tools to foster new user connections and social influence marketing. Advertisers may display ads during live broadcasts and collect user profile information.

Embodiments of the present invention may include, for example, setting a recording location, scheduling events such as a live interview with a celebrity, and publishing the event on the web in a manner that draws listeners into using the inventive system's methodology to connect with the celebrity, all the while triggering steps that encourage the listener to promote his/her involvement and activity through social network environments. The system administrator may have the ability to manage an entire event lifecycle before, during and after the event in a way that enhances the benefit to the listener and the celebrity while monetizing the process steps for advertisers.

As can be appreciated, the program may be hosted on television or through the internet, and may be hosted by a system provider or by the celebrity themselves, where, for example, the celebrity may choose to implement an embodiment in which the celebrity functions also as the administrator of the system and simply avails herself directly to the consumers without the need for pre-existing programming environments such as talk shows. Importantly, the value of the systems and methodologies herein is their ability to draw both celebrities and fans/consumers in a way that maximizes monetization of the connection between star and fan while delighting and benefiting both parties.

According to an embodiment of the present disclosure, a machine-readable medium that provides instructions, which when read by a machine having a processor and a memory, cause the machine to perform operations according to any of the methods described above is also provided.

While the systems, methods, and machine readable media have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

It should also be understood that a variety of changes may be made without departing from the essence of the invention. Such changes are also implicitly included in the description. They still fall within the scope of the invention. It should be understood that this disclosure is intended to yield a patent or patents covering numerous aspects of the inventions both independently and as an overall system, machine-readable media and in both method and apparatus modes.

Further, each of the various elements of the inventions and claims may also be achieved in a variety of manners. This disclosure should be understood to encompass each such variation of an embodiment of any apparatus embodiment, a method, machine-readable medium or process embodiment, or even merely a variation of any element of these.

Particularly, it should be understood that as the disclosure relates to elements of the inventions, the words for each element may be expressed by equivalent apparatus terms of method terms—even if only the function or result is the same. Such equivalent, broader, or eve more generic terms should be considered to be encompassed in the description of each element or action. Such terms can be substituted where desired to make explicit the implicitly broad coverage to which this invention is entitled.

It should be understood that all actions may be expressed as a means for taking that action or as an element which causes that action. Similarly, each physical element disclosed should be understood to encompass a disclosure of the action which that physical element facilitates.

Any patents, publications, or other references mentioned in this application for patent are hereby incorporated by reference. In addition, as to each term used, it should be understood that unless its utilization in this application is inconsistent with such interpretation, common dictionary definitions should be understood as incorporated for each term and all definitions, alternative terms, and synonyms such as contained in at least one of a standard technical dictionary recognized by artisans, incorporated herein by reference.

Further, all claim terms should be interpreted in their most expansive forms so as to afford the applicant the broadest coverage legally permissible. Although the embodiments have been described with reference to the drawings and specific examples, it will readily be appreciated by skilled artisans that many modifications and adaptations of the processes and apparatuses described herein are possible without departure from the spirit and scope of the invention. Thus, it is to be clearly understood that this description is made only by way of example and not as a limitation on the scope of the embodiments as claimed below.

What is claimed is:

1. A computer-implemented method for providing an interface between fans and celebrities, the method comprising:
prompting, via a processor, a plurality of users to participate in a programming session with a celebrity;
storing a plurality of media submissions in a memory, each media submission being associated with a user for consideration and presentation to the celebrity during the programming session;
selecting, via the processor and based on at least one predetermined criteria, at least one of the plurality of the media submissions for presentation during the programming session; and
identifying, via the processor, the selection of a user's media submission for presentation during the programming session on at least one social network account associated with the user.

2. The computer-implemented method of claim 1, further comprising integrating, via the processor, an advertisement banner with the interface between fans and celebrities.

3. The computer-implemented method of claim 1, further comprising integrating, via the processor, an advertisement banner with the at least one social network account associated with the user interface between fans and celebrities.

4. The computer-implemented method of claim 1, wherein the predetermined criteria is a random selection of the at least one of the plurality of the media submissions.

5. The computer-implemented method of claim 1, wherein the predetermined criteria is based upon a number of credits issued to the plurality of users.

6. The computer-implemented method of claim 1, wherein the predetermined criteria is based upon a number of credits purchased by the user.

7. The computer-implemented method of claim 1, further comprising streaming the programming session live for output at a user's terminal.

8. The computer-implemented method of claim 7, wherein the streaming of the programming session comprises transmitting video data of at least one of the celebrity and the event management personnel for video output at the user's terminal.

9. A machine-readable medium that provides instructions, which when read by a machine having a processor and a memory, cause the machine to perform operations, comprising:
prompting, via the processor, a plurality of users to participate in a programming session with a celebrity;
storing a plurality of media submissions in the memory, each media submission being associated with a user for consideration and presentation to the celebrity during the programming session;
selecting, via the processor and based on at least one predetermined criteria, at least one of the plurality of the media submissions for presentation during the programming session; and
identifying, via the processor, the selection of a user's media submission for presentation during the programming session on at least one social network account associated with the user.

10. The machine-readable medium of claim 9, further comprising integrating, via the processor, an advertisement banner with the interface between fans and celebrities.

11. The machine-readable medium of claim 9, further comprising integrating, via the processor, an advertisement banner with the at least one social network account associated with the user interface between fans and celebrities.

12. The machine-readable medium of claim 9, wherein the predetermined criteria is a random selection of the at least one of the plurality of the media submissions.

13. The machine-readable medium of claim 9, wherein the predetermined criteria is based upon a number of credits issued to the plurality of users.

14. The machine-readable medium of claim 9, wherein the predetermined criteria is based upon a number of credits purchased by the user.

15. The machine-readable medium of claim 9, further comprising streaming the programming session live for output at a user's terminal.

16. The machine-readable medium of claim 9, wherein the streaming of the programming session comprises transmitting video data of at least one of the celebrity and the event management personnel for video output at the user's terminal.

17. A system for providing an interface between fans and celebrities, the system comprising:
a memory for storing a plurality of media submissions, each media submission being associated with a user for consideration and presentation to the celebrity during the programming session; and
a processor programmed with instructions to:
prompt a plurality of users to participate in a programming session with a celebrity;
select, based on at least one predetermined criteria, at least one of the plurality of the media submissions for presentation during the programming session; and
identify the selection of a user's media submission for presentation during the programming session on at least one social network account associated with the user.

18. The system of claim 17, wherein the processor is further programmed with instructions to integrate an advertisement banner with the interface between fans and celebrities.

19. The system claim 17, wherein the processor is further programmed with instructions to stream the programming session live for output at a user's terminal.

20. The system claim 19, wherein the streaming of the programming session comprises transmitting video data of at least one of the celebrity and the event management personnel for video output at the user's terminal.
